(19) United States
(12) Patent Application Publication
(10) Pub. No.: US 2025/0333126 A1
(43) Pub. Date: Oct. 30, 2025

(54) WHEEL-LEGGED TRAVELING DEVICE AND WHEEL-LEGGED ROBOT

(71) Applicant: Beijing Youzhuju Network Technology Co., Ltd., Beijing (CN)

(72) Inventors: Guangzeng Chen, Beijing (CN); Tao Kong, Beijing (CN); Jiafeng Xu, Beijing (BE); Yifeng Li, Beijing (CN); Taozheng Yang, Beijing (CN)

(21) Appl. No.: 19/033,450

(22) Filed: Jan. 21, 2025

(30) Foreign Application Priority Data
Apr. 24, 2024 (CN) 202410502018.5

(51) Int. Cl. B62D 57/028; B60K 7/00

(52) U.S. Cl. CPC B62D 57/028; B60K 7/0007

(57) ABSTRACT

According to embodiments of the disclosure, a wheel-legged traveling device and a wheel-legged robot are provided. The wheel-legged traveling device includes: a main body extending in a main body direction; a wheeled traveling mechanism rotatably coupled to a first end of the main body in the main body direction and including at least one driving wheel to drive the wheel-legged traveling device to move; and at least one pair of legged traveling mechanisms at least coupled to a second end of the main body opposite the first end in the main body direction, and the at least one pair of legged traveling mechanisms respectively arranged on two sides of the main body direction, to be adapted to drive the wheel-legged traveling device to move in an alternating motion manner.

### CROSS-REFERENCE

The present application claims priority to Chinese Patent Application No. 202410502018.5, filed on Apr. 24, 2024, and entitled “WHEEL-LEGGED TRAVELING DEVICE AND WHEEL-LEGGED ROBOT”, which is incorporated herein by reference in its entirety.

### FIELD

Example embodiments of the present disclosure generally relate to the field of robots, and in particular, to a wheel-legged traveling device and a wheel-legged robot.

### BACKGROUND

With the continuous development of science and technology, various types of robots gradually come into people's lives and undertakes increasingly diverse functions in daily life.

An existing wheeled robot generally includes at least a pair of driving wheels and a pair of driven wheels, and the robot is driven to travel through rolling of the driving wheels and driven wheels. However, such wheeled robot is difficult to be applied to complex road conditions requiring crossing, climbing and the like.

### SUMMARY

In a first aspect of the present disclosure, a wheel-legged traveling device is provided. The wheel-legged traveling device includes: a main body extending in a main body direction; a wheeled traveling mechanism rotatably coupled to a first end of the main body in the main body direction and including at least one driving wheel to drive the wheel-legged traveling device to move; and at least one pair of legged traveling mechanisms at least coupled to a second end of the main body opposite the first end in the main body direction, and the at least one pair of legged traveling mechanisms respectively arranged on two sides of the main body direction, to be adapted to drive the wheel-legged traveling device to move in an alternating motion manner.

In some embodiments, each of the wheeled traveling mechanism and the at least one pair of legged traveling mechanisms includes a support assembly, and the support assembly includes: an upper leg bracket rotatably coupled to the main body; and a lower leg bracket rotatably coupled to an end of a corresponding upper leg bracket away from the main body.

In some embodiments, the support assembly further includes: at least one adjustment mechanism, coupled between the wheeled traveling mechanism and the main body and/or between the legged traveling mechanism and the main body, and adapted to provide a plurality of degrees of freedom of motion to the wheeled traveling mechanism or the legged traveling mechanisms relative to the main body.

In some embodiments, the adjustment mechanism includes: a base coupled to the main body; and a first motor, coupled to the base, and adapted to drive the upper leg bracket to rotate around a first rotation direction.

In some embodiments, the adjustment mechanism further includes: a connecting rod assembly, arranged between the upper leg bracket and the lower leg bracket and including a first connecting rod and a second connecting rod hinged to each other, wherein an end of the first connecting rod away from the second connecting rod is rotatably coupled to the upper leg bracket, and an end of the second connecting rod away from the first connecting rod is rotatably coupled to the lower leg bracket; and a second motor, coupled to the base, and adapted to drive the lower leg bracket to rotate around a second rotation direction by driving the connecting rod assembly to move.

In some embodiments, the adjustment mechanism further includes: a third motor, arranged between the main body and the base, and adapted to drive the base to rotate around a third rotation direction, and wherein a predetermined angle is formed between the third rotation direction and the first rotation direction.

In some embodiments, the legged traveling mechanisms include: a driven wheel, coupled to the lower leg bracket, and adapted to roll on the ground at least during movement of the wheel-legged traveling device driven by the driving wheel.

In some embodiments, the legged traveling mechanisms further includes a mounting bracket, which is arranged between the lower leg bracket and the driven wheel and is pivotably coupled to the lower leg bracket to at least drive the driven wheel to rotate around a fourth rotation direction, and wherein the fourth rotation direction is arranged to form a predetermined non-zero angle relative to a plane formed by the third rotation direction and the first rotation direction.

In some embodiments, the driving wheel includes: a rim; and a drive motor, coupled to the rim, and adapted to drive the rim to rotate around its own axis.

In some embodiments, the drive motor includes at least one of an in-wheel motor or a wheel-side motor.

In some embodiments, the wheeled traveling mechanism further includes a steering wheel assembly adapted to drive the driving wheel to rotate around a fifth rotation direction, and the steering wheel assembly includes: an upper housing coupled to the lower leg bracket; a lower housing coupled to the driving wheel; and a steering motor, arranged between the upper housing and the lower housing, and adapted to drive the lower housing to rotate around a fifth rotation direction relative to the upper housing, and wherein the fifth rotation direction is arranged to form a predetermined non-zero angle relative to a plane formed by the third rotation direction and the first rotation direction.

In some embodiments, the at least one driving wheel includes a pair of driving wheels, which are coaxially arranged on opposite sides of the steering wheel assembly.

In the wheel-legged traveling device, the wheeled traveling mechanism and the legged traveling mechanisms are coupled to the main body respectively. Therefore, when the wheel-legged traveling device moves, the wheel-legged traveling device not only can use the wheeled traveling mechanism to drive the device to travel, but also can simulate walking posture of the human body through the legged traveling mechanisms under a complex road surface environment, thereby obtaining better passing performance. The combination of the wheeled traveling mechanism and the legged traveling mechanisms enables the wheel-legged traveling device to cross obstacles such as steps and the like in a path in a “climbing” posture, and meanwhile, through posture adjustment of the support assembly by the adjustment mechanism, it is also possible to reduce vibration of the wheel-legged traveling device when traveling on a pothole road surface, improve stability of traveling, and reduce occurrence of a rollover, etc.

In a second aspect of the present disclosure, a wheel-legged traveling robot is provided. The wheel-legged traveling robot includes the wheel-legged traveling device provided according to the first aspect of the present disclosure.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 shows a schematic view of an overall structure of a wheel-legged traveling device according to some embodiments of the present disclosure;

FIG. 2 shows a schematic view of an internal structure of a wheel-legged traveling device according to some embodiments of the present disclosure;

FIG. 3 shows an exploded view of a wheel-legged traveling device according to some embodiments of the present disclosure;

FIG. 4 shows a schematic view of a connection relationship between legged traveling mechanisms and a support assembly according to some embodiments of the present disclosure;

FIG. 5 shows a schematic view of a portion of a support assembly coupled to a wheeled traveling mechanism according to some embodiments of the present disclosure; and

FIG. 6 shows an exploded view of the support assembly of FIG. 5.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the terms “including” and the like should be understood to include “including but not limited to”. The term “based on” should be understood as “based at least in part on”. The terms “an embodiment” or “the embodiment” should be understood as “at least one embodiment”. The term “some embodiments” should be understood as “at least some embodiments”. Other explicit and implicit definitions may also be included below. The terms “first”, “second”, and the like may refer to different or identical objects. Other explicit and implicit definitions may also be included below.

As briefly mentioned above, conventional wheeled robots rely on rotation of at least one pair of traveling wheels to move on the ground. However, the wheeled robot with such structure cannot be well adapted to complex road surface environments. For example, when the wheeled robot travels on a pothole road surface, the wheeled robot has poor stability and is prone to rollover and the like. When there are obstacles (e.g., steps, stairs, a shoulder, etc.) on a travel route, it is difficult for the wheeled robot to cross these obstacles.

Embodiments of the present disclosure provide a wheel-legged traveling device and a wheel-legged robot to solve or at least partially solve the above problems and other potential problems existing in the conventional solution. According to various embodiments of the present disclosure, in the wheel-legged traveling device, the wheeled traveling mechanism and the legged traveling mechanism are coupled to the main body respectively, so that when the wheel-legged traveling device moves, the wheel-legged traveling device not only can use the wheeled traveling mechanism to drive the device to travel, but also can simulate walking posture of the human body through the legged traveling mechanisms under a complex road surface environment, thereby obtaining better passing performance. The combination of the wheeled traveling mechanism and the legged traveling mechanisms enable the wheel-legged traveling device to cross obstacles such as steps and the like in a path in a “climbing” posture, and meanwhile, through posture adjustment of the support assembly by an adjustment mechanism, it is also possible to reduce vibration of the wheel-legged traveling device when traveling on a pothole road surface, improve stability of traveling, and reduce occurrence of a rollover, etc.

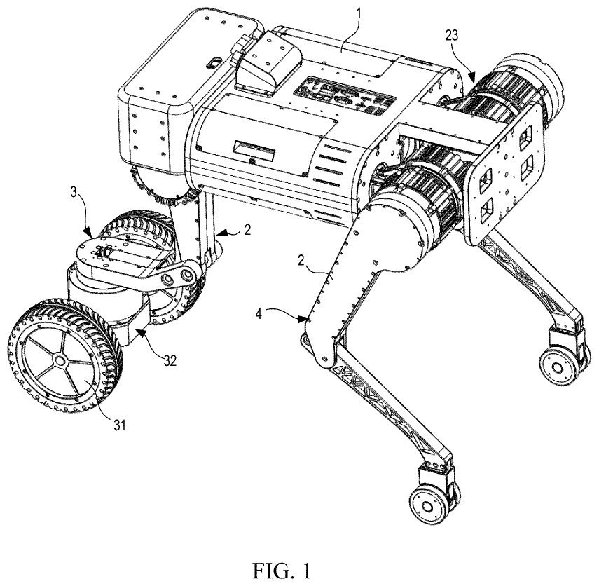

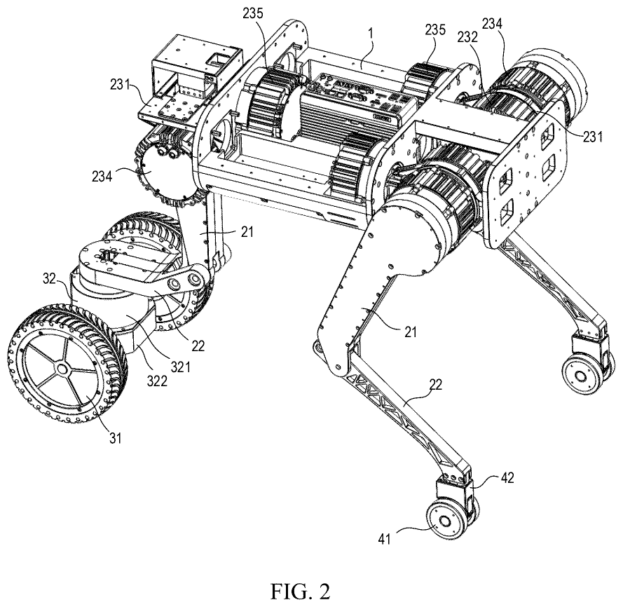

FIG. 1 shows a schematic view of an overall structure of a wheel-legged traveling device according to some embodiments of the present disclosure, and FIG. 2 shows a schematic view of an internal structure of the wheel-legged traveling device according to some embodiments of the present disclosure. As shown in FIGS. 1 and 2, the wheel-legged traveling device includes a main body 1, a wheeled traveling mechanism 3, and at least one pair of legged traveling mechanisms 4. The wheel-legged robot includes the wheel-legged traveling device and an action component coupled to the wheel-legged traveling device. For example, the action component may be a manipulator, a payload platform, or any other suitable mechanical or electronic device coupled to the main body 1.

The wheeled traveling mechanism 3 and the at least one pair of legged traveling mechanisms 4 are arranged in a main body direction of the wheel-legged traveling device. Specifically, the wheeled traveling mechanism 3 is rotatably coupled to a first end of the main body 1 in the main body direction, and the at least one pair of legged traveling mechanisms 4 at least are coupled to a second end of the main body 1 opposite the first end. For example, a pair of legged traveling mechanisms 4 are coupled to a second end of the main body 1 opposite the first end in FIG. 1. Of course, it should be understood that the at least one pair of legged traveling mechanisms 4 may also include a plurality of pairs of legged traveling mechanisms 4. In addition to coupling a pair of legged traveling mechanisms 4 to the second end, the other legged traveling mechanisms 4 of the plurality of pairs of legged traveling mechanisms 4 may also be coupled to an appropriate location between the first end and the second end. Embodiments of the present disclosure are described mainly by taking the pair of legged traveling mechanisms 4 shown in the figures as an example. It should be understood that, it is similar for a case including a plurality of pairs of legged traveling mechanisms 4, and details will not be described separately again hereafter. In some embodiments, the first end is rearward and the second end may be forward, i.e., the at least one pair of legged traveling mechanisms 4 are arranged in front of the wheeled traveling mechanism 3 in a traveling direction. Two legged traveling mechanisms 4 of each pair of legged traveling mechanisms 4 are respectively arranged on two sides of the main body 1 in the traveling direction.

According to various embodiments of the present disclosure, in the wheel-legged traveling device, the wheeled traveling mechanism and the legged traveling mechanisms are coupled to the main body respectively, so that when the wheel-legged traveling device moves, the wheel-legged traveling device not only can use the wheeled traveling mechanism to drive the device to travel, but also can simulate walking posture of the human body through the legged traveling mechanisms under a complex road surface environment, thereby obtaining better passing performance. The combination of the wheeled traveling mechanism and the legged traveling mechanisms enables the wheel-legged traveling device to cross obstacles such as steps and the like in a path in a “climbing” posture, and meanwhile, through posture adjustment of the support assembly by an adjustment mechanism, it is also possible to reduce vibration of the wheel-legged traveling device when traveling on a pothole road surface, improve stability of the traveling, and reduce occurrence of a rollover, etc.

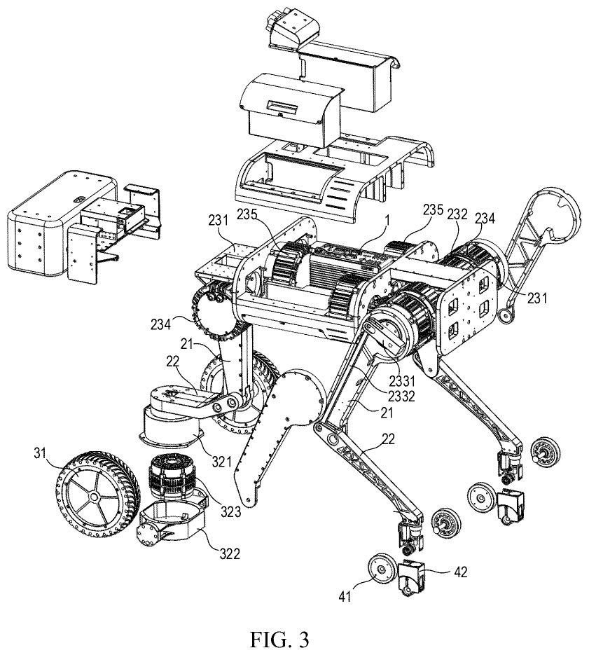

In some embodiments, each of the wheeled traveling mechanism 3 and the at least one pair of legged traveling mechanisms 4 may include a support assembly. FIG. 3 shows an exploded view of the wheel-legged traveling device according to some embodiments of the present disclosure. As shown in FIG. 3, the support assembly 2 is adapted to support the main body 1 such that the main body 1 is lifted off the ground at a predetermined distance. The support assembly 2 includes an upper leg bracket 21 and a lower leg bracket 22 corresponding to the upper leg bracket 21. An end of the upper leg bracket 21 is rotatably coupled to the main body 1, and the other end is rotatably coupled to the lower leg bracket 22.

In some embodiments, the support assembly 2 may further include at least one adjustment mechanism 23 coupled between the wheeled traveling mechanism 3 and the main body 1 or between the legged traveling mechanisms 4 and the main body 1. The adjustment mechanism 23 enables the wheeled traveling mechanism 3 and/or the legged traveling mechanisms 4 to move in a plurality of degrees of freedom relative to the main body 1 by adjusting relative position between the upper leg bracket 21 and the lower leg bracket 22.

By controlling movements of the upper leg bracket 21 and the lower leg bracket 22 relative to the position of the main body 1, the distance at which the main body 1 is lifted off the ground can be adjusted. In some cases, the main body 1 may be tilted accordingly when the adjustment mechanism 23 adjusts the relative position of a certain or some of the upper leg brackets 21 and/or the lower leg brackets 22. Thereby, the posture of the main body 1 can be adjusted in the above manner, to enable keeping the main body 1 and the action component coupled to the main body 1 relatively stable during movement of the wheel-legged traveling device on the complex road surface. The adjustment mechanism 23 will be described in detail hereinafter.

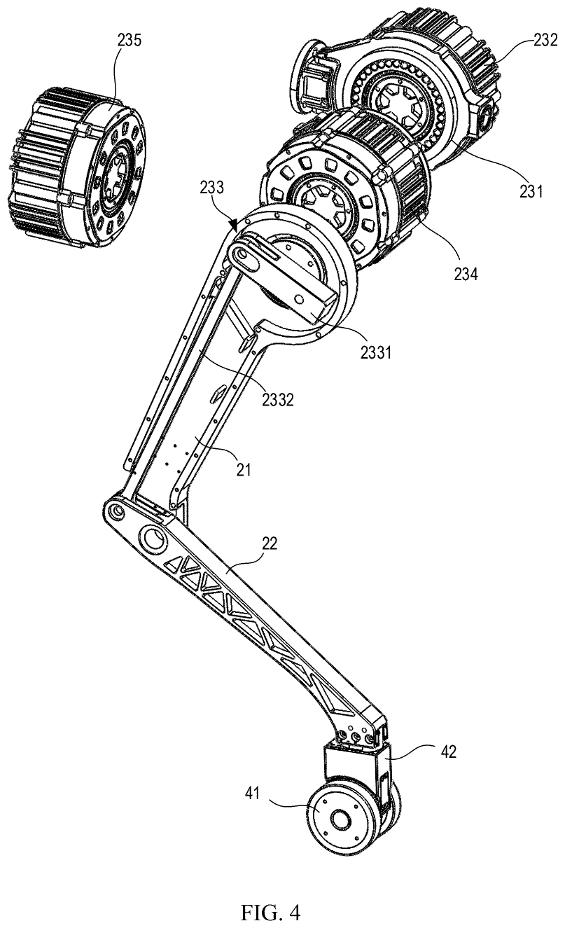

FIG. 4 shows a schematic view of a connection relationship between the legged traveling mechanisms 4 and the support assembly 2 according to some embodiments of the present disclosure. As shown in FIG. 4 and with reference to FIG. 3, the legged traveling mechanisms 4 further includes a driven wheel 41 coupled to the lower leg bracket 22, and the driven wheel 41 is adapted to passively rotate under the driving of the wheeled traveling mechanism 3. In some embodiments, the legged travelling mechanisms 4 further include a mounting bracket 42, the mounting bracket 42 is arranged between the lower leg bracket 22 and the driven wheel 41, and the mounting bracket 42 is pivotally coupled to the lower leg bracket 22, so that the mounting bracket 42 may drive the driven wheel 41 to rotate around a fourth rotation direction. In some embodiments, the fourth rotation direction may be arranged parallel to a direction of gravity.

Returning to FIG. 3, the wheeled traveling mechanism 3 of the present disclosure includes a driving wheel 31, the driving wheel 31 is coupled to the lower leg bracket 22, and an outer peripheral surface of the driving wheel 31 abuts against the ground, so that when the driving wheel 31 rotates, the driving wheel 31 can drive the wheel-legged traveling device to move. In some embodiments, the driving wheel 31 includes a rim and a drive motor coupled to the rim, and the drive motor may be an in-wheel motor or a wheel-side motor. When the driving motor is powered on, the drive motor drives the rim to rotate and thus drive the wheel-legged traveling device to move.

In some embodiments, the wheeled traveling mechanism 3 includes a pair of driving wheels 31, the pair of driving wheels 31 are coaxially arranged on two sides of the lower leg bracket 22, and thus the rims of the pair of driving wheels 31 can be respectively driven by respective driving motors. When two rims operate at the same rotation speed, the wheel-legged traveling device may travel in a linear direction. When the rotation speeds of the two rims are different, the wheel-legged traveling device can perform actions such as steering and the like.

In some embodiments, the wheeled traveling mechanism 3 further includes a steering wheel assembly 32, the steering wheel assembly 32 is arranged between the driving wheel 31 and the lower leg bracket 22 of the support assembly 2. The steering wheel assembly 32 includes an upper housing 321, a lower housing 322, and a steering motor 323 arranged between the upper housing 321 and the lower housing 322. The upper housing 321 is coupled to the lower leg bracket 22, the lower housing 322 is coupled to the driving wheel 31, and a body and an output shaft of the steering motor 323 are respectively coupled to the upper housing 321 and the lower housing 322. The output shaft of the steering motor 323 is arranged along a fifth rotation direction, so that the steering motor 323 may control the upper housing 321 and the lower housing 322 to rotate relative to each other around the fifth rotation direction, and thus enable the wheeled traveling mechanism 3 to provide propulsive force in different directions to the main body 1, thereby facilitating to drive the wheel-legged traveling device to perform operations such as steering and the like.

The steering wheel assembly 32 may further interact with the adjustment of rotation speed of the pair of driving wheels 31, thereby improving the flexibility of the action of the wheel-legged traveling device, for example, reducing the steering radius of the wheel-legged traveling device.

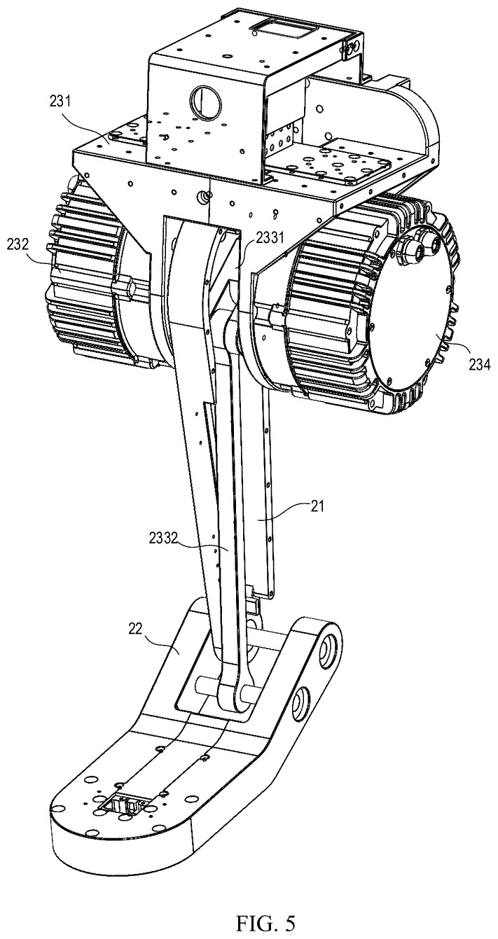

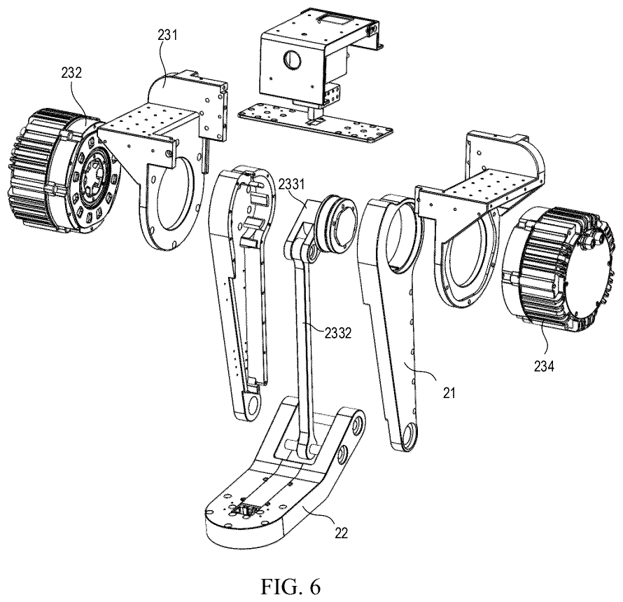

FIG. 5 shows a schematic view of a portion of the support assembly 2 coupled with the wheeled traveling mechanism 3 according to some embodiments of the present disclosure, and FIG. 6 shows an exploded view of the support assembly 2 of FIG. 5. As shown in FIGS. 5 and 6 and with reference to FIG. 4, in some embodiments, the adjustment mechanism 23 includes a base 231 and a first motor 232, the base 231 is coupled to the main body 1, and an end of the upper leg bracket 21 away from the lower leg bracket 22 is rotatably coupled to the base 231, so that the upper leg bracket 21 may rotate relative to the base 231 around a first rotation direction. The first motor 232 is arranged between the base 231 and the upper leg bracket 21, and is coupled to the base 231, and is adapted to drive the upper leg bracket 21 to rotate around the first rotation direction after the first motor 232 is powered on.

It should be understood that motor (including the steering motor 323, the first motor 232, and a second motor 234 and a third motor 235 mentioned below, etc.) in the present disclosure being arranged between two parts (for example, the steering motor 323 is arranged between the upper housing 321 and the lower housing 322) refers to that a body and an output shaft of the motor are respectively coupled to two parts, so that the motor can drive the two parts to rotate relative to each other. For example, in some embodiments, the body of the motor can be coupled to a first part, and the output shaft of the motor can be coupled to a second part.

In some alternative embodiments, the output shaft of motor may be coupled to the first part, and the body of the motor may be coupled to the second part. On the other hand, in the present disclosure, the output shaft of the motor may be directly or indirectly connected to the coupled part. For example, in some embodiments, the output shaft of the motor may be directly coupled to the first part by means of a spline fit. In other embodiments, a device such as a coupling, a transmission, and/or a clutch may be suitably added between the output shaft of the motor and the coupled part, to improve accuracy and stability of rotation of the part driven by the motor.

In some embodiments, a rotating shaft between the lower leg bracket 22 and the upper leg bracket 21 extends in the second rotation direction, and the adjustment mechanism 23 is further adapted to drive the lower leg bracket 22 to rotate relative to the upper leg bracket 21 around the second rotation direction. The adjustment mechanism 23 further includes a connecting rod assembly 233 and a second motor 234, the connecting rod assembly 233 includes a first connecting rod 2331 and a second connecting rod 2332 hinged to each other at ends, an end of the first connecting rod 2331 away from the second connecting rod 2332 is coupled to the upper leg bracket 21, and an end of the second connecting rod 2332 away from the first connecting rod 2331 is coupled to the lower leg bracket 22. Therefore, the upper leg bracket 21, the first connecting rod 2331, the second connecting rod 2332, and the lower leg bracket 22 are sequentially connected and form a parallel four-bar linkage structure. The second motor 234 is arranged between the first connecting rod 2331 and the base 231, and when the second motor 234 works, the second motor drives the lower leg bracket 22 to rotate relative to the upper leg bracket 21 around the second rotation direction through the connecting rod assembly 233.

In some embodiments, the first rotation direction and the second rotation direction may be parallel, and in other embodiments, the first rotation direction and the second rotation direction may form a predetermined angle.

Depending on the position of the upper leg bracket 21 coupled to the main body 1, the arrangement relationship of the first motor 232 and the second motor relative to the base 231 can be correspondingly adjusted. For example, for the adjustment mechanism 23 arranged between the wheeled traveling mechanism 3 and the main body 1, the first motor 232 and the second motor can be arranged on opposite sides of the base 231, and for the adjustment mechanism 23 arranged between the legged travelling mechanisms 4 and the main body 1, the first motor 232 and the second motor 234 can be arranged on a side of the base 231 facing away from a center line of the main body 1. In some embodiments, the output shafts of the first motor 232 and the second motor 234 may be coaxially disposed, for example, the output shaft of the second motor 234 may pass through the output shaft of the first motor 232 and be coupled to the first connecting rod 2331.

In some embodiments, the adjustment mechanism 23 further includes a third motor 235, the third motor 235 is arranged between the base 231 and the main body 1, and the third motor 235 is adapted to drive the base 231 and the upper leg bracket 21, the lower leg bracket 22, and the wheeled traveling mechanism 3 and the legged travelling mechanisms 4 coupled to the base 231 to rotate around a third rotation direction. In some embodiments, the third rotation direction is parallel to the traveling direction. In some embodiments, the third rotation direction may form a predetermined angle relative to the traveling direction, for example, the third rotation direction and the traveling direction may also form a predetermined angle (for example, 10°).

When the first motor 232, the second motor and the third motor 235 of the adjustment mechanism 23 work, the wheeled traveling mechanism 3 and the legged traveling mechanism 4 coupled to the lower leg bracket 22 can be driven to move at least three degrees of freedom. That is, the base 231 rotates relative to the main body 1 around the third rotation direction, the upper leg bracket 21 rotates relative to the base 231 around the first rotation direction, and the lower leg bracket 22 rotates relative to the upper leg bracket 21 around the second rotation direction.

Adjustment mechanism 23 may adjust a positional relationship of the main body 1 relative to the ground (e.g., a distance from the ground) or a current posture of the main body 1 (e.g., whether the main body 1 is in a horizontal state). The adjustment mechanism 23 is further adapted to drive the at least one pair of legged traveling mechanisms 4 to perform actions such as climbing and the like. For example, when the wheel-legged traveling device needs to cross obstacles such as steps and the like, the pair of legged traveling mechanisms 4 of the wheel-legged traveling device alternately lift up and advance in the traveling direction, thereby the legged traveling mechanisms 4 are lifted up to upper surface of the steps. Subsequently, the whole of the wheeled traveling mechanism 3 approaches towards the steps such that a center of gravity of the wheel-legged traveling device gradually approaches the steps and moves above the steps. During this time, the adjustment mechanism 23 coupled to the wheeled traveling mechanism 3 drives the main body 1 away from the ground to prevent the wheel-legged traveling device from coming into contact with the steps as it approaches towards the steps. Finally, since the center of gravity of the wheel-legged traveling device has been moved above the upper surface of the steps, and the wheeled traveling mechanism can also smoothly roll over the steps, thereby enabling the wheel-legged traveling device to cross obstacles such as steps and the like.

Returning to FIG. 3, in some embodiments, the fourth rotation direction is configured to form a predetermined non-zero angle relative to a plane formed by the first rotation direction and the third rotation direction. For example, the first rotation direction, the third rotation direction, and the fourth rotation direction are perpendicular to each other, and in this manner, the flexibility of adjustment of the driven wheel 41 can be improved.

In some embodiments, the fifth rotation direction of the steering wheel assembly 32 is arranged to form a predetermined angle relative to a plane formed by the first rotation direction and the third rotation direction of the adjustment mechanism 23. In some alternative embodiments, the first rotation direction, the third rotation direction, and the fifth rotation direction are perpendicular to each other.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A wheel-legged traveling device, comprising:
a main body extending in a main body direction;
a wheeled traveling mechanism rotatably coupled to a first end of the main body in the main body direction, and comprising at least one driving wheel to drive the wheel-legged traveling device to move; and
at least one pair of legged traveling mechanisms at least coupled to a second end of the main body opposite the first end in the main body direction, and the at least one pair of legged traveling mechanisms respectively arranged on two sides of the main body direction, to be adapted to drive the wheel-legged traveling device to move in an alternating motion manner.

2. The wheel-legged traveling device of claim 1, wherein each of the wheeled traveling mechanism and the at least one pair of legged traveling mechanisms comprises a support assembly, and the support assembly comprises:
an upper leg bracket rotatably coupled to the main body; and
a lower leg bracket rotatably coupled to an end of a corresponding upper leg bracket away from the main body.

3. The wheel-legged traveling device of claim 2, wherein the support assembly further comprises:
at least one adjustment mechanism, coupled between the wheeled traveling mechanism and the main body and/or between the legged traveling mechanisms and the main body, and adapted to provide a plurality of degrees of freedom of motion to the wheeled traveling mechanism or the legged traveling mechanisms relative to the main body.

4. The wheel-legged traveling device of claim 3, wherein the adjustment mechanism comprises:
a base coupled to the main body; and
a first motor, coupled to the base, and adapted to drive the upper leg bracket to rotate around a first rotation direction.

5. The wheel-legged traveling device of claim 4, wherein the adjustment mechanism further comprises:
a connecting rod assembly, arranged between the upper leg bracket and the lower leg bracket, and comprising a first connecting rod and a second connecting rod hinged to each other, wherein an end of the first connecting rod away from the second connecting rod is rotatably coupled to the upper leg bracket, and an end of the second connecting rod away from the first connecting rod is rotatably coupled to the lower leg bracket; and
a second motor, coupled to the base, and adapted to drive the lower leg bracket to rotate around a second rotation direction by driving the connecting rod assembly to move.

6. The wheel-legged traveling device of claim 5, wherein the adjustment mechanism further comprises:
a third motor, arranged between the main body and the base, and adapted to drive the base to rotate around a third rotation direction, and
wherein a predetermined angle is formed between the third rotation direction and the first rotation direction.

7. The wheel-legged traveling device of claim 6, wherein the legged traveling mechanisms comprise:
a driven wheel, coupled to the lower leg bracket, and adapted to roll on the ground at least during movement of the wheel-legged traveling device driven by the driving wheel.

8. The wheel-legged traveling device of claim 7, wherein the legged travelling mechanisms further comprises a mounting bracket, which is arranged between the lower leg bracket and the driven wheel and is pivotably coupled to the lower leg bracket to at least drive the driven wheel to rotate around a fourth rotation direction, and
wherein the fourth rotation direction is arranged to form a predetermined non-zero angle relative to a plane formed by the third rotation direction and the first rotation direction.

9. The wheel-legged traveling device of claim 6, wherein the driving wheel comprises:
a rim; and
a drive motor, coupled to the rim, and adapted to drive the rim to rotate around its own axis.

10. The wheel-legged traveling device of claim 9, wherein the drive motor comprises at least one of an in-wheel motor or a wheel-side motor.

11. The wheel-legged traveling device of claim 9, wherein the wheeled traveling mechanism further comprises a steering wheel assembly adapted to drive the driving wheel to rotate around a fifth rotation direction, and the steering wheel assembly comprises:
an upper housing coupled to the lower leg bracket;
a lower housing coupled to the driving wheel; and
a steering motor, arranged between the upper housing and the lower housing, and adapted to drive the lower housing to rotate around a fifth rotation direction relative to the upper housing, and
wherein the fifth rotation direction is arranged to form a predetermined non-zero angle relative to a plane formed by the third rotation direction and the first rotation direction.

12. The wheel-legged traveling device of claim 9, wherein the at least one driving wheel comprises a pair of driving wheels, which are coaxially arranged on opposite sides of the steering wheel assembly.

13. A wheel-legged traveling robot comprising a wheel-legged traveling device, wherein the wheel-legged traveling device comprises:
a main body extending in a main body direction;
a wheeled traveling mechanism rotatably coupled to a first end of the main body in the main body direction, and comprising at least one driving wheel to drive the wheel-legged traveling device to move; and
at least one pair of legged traveling mechanisms at least coupled to a second end of the main body opposite the first end in the main body direction, and the at least one pair of legged traveling mechanisms respectively arranged on two sides of the main body direction, to be adapted to drive the wheel-legged traveling device to move in an alternating motion manner.

14. The wheel-legged traveling robot of claim 13, wherein each of the wheeled traveling mechanism and the at least one pair of legged traveling mechanisms comprises a support assembly, and the support assembly comprises:
an upper leg bracket rotatably coupled to the main body; and
a lower leg bracket rotatably coupled to an end of a corresponding upper leg bracket away from the main body.

15. The wheel-legged traveling robot of claim 14, wherein the support assembly further comprises:
at least one adjustment mechanism, coupled between the wheeled traveling mechanism and the main body and/or between the legged traveling mechanisms and the main body, and adapted to provide a plurality of degrees of freedom of motion to the wheeled traveling mechanism or the legged traveling mechanisms relative to the main body.

16. The wheel-legged traveling robot of claim 15, wherein the adjustment mechanism comprises:
a base coupled to the main body; and
a first motor, coupled to the base, and adapted to drive the upper leg bracket to rotate around a first rotation direction.

17. The wheel-legged traveling robot of claim 16, wherein the adjustment mechanism further comprises:
a connecting rod assembly, arranged between the upper leg bracket and the lower leg bracket, and comprising a first connecting rod and a second connecting rod hinged to each other, wherein an end of the first connecting rod away from the second connecting rod is rotatably coupled to the upper leg bracket, and an end of the second connecting rod away from the first connecting rod is rotatably coupled to the lower leg bracket; and
a second motor, coupled to the base, and adapted to drive the lower leg bracket to rotate around a second rotation direction by driving the connecting rod assembly to move.

18. The wheel-legged traveling robot of claim 17, wherein the adjustment mechanism further comprises:
a third motor, arranged between the main body and the base, and adapted to drive the base to rotate around a third rotation direction, and
wherein a predetermined angle is formed between the third rotation direction and the first rotation direction.

19. The wheel-legged traveling robot of claim 17, wherein the legged traveling mechanisms comprise:
a driven wheel, coupled to the lower leg bracket, and adapted to roll on the ground at least during movement of the wheel-legged traveling device driven by the driving wheel.

20. The wheel-legged traveling robot of claim 19, wherein the legged travelling mechanisms further comprises a mounting bracket, which is arranged between the lower leg bracket and the driven wheel and is pivotably coupled to the lower leg bracket to at least drive the driven wheel to rotate around a fourth rotation direction, and
wherein the fourth rotation direction is arranged to form a predetermined non-zero angle relative to a plane formed by the third rotation direction and the first rotation direction.
